(19) United States
(12) Patent Application Publication
(10) Pub. No.: US 2008/0155957 A1
(43) Pub. Date: Jul. 3, 2008

(54) Rotary, continuous, combustion turbine

(76) Inventor: Hugh Joseph Gallagher, Tucson, AZ (US)

Correspondence Address: Hugh Gallagher M.D., 8423 N. Coral Ridge Loop, Tucson, AZ, 85704, US

(21) Appl. No.: 11/648,747

(22) Filed: Jan. 3, 2007

(51) Int. Cl. F02C 3/00

(52) U.S. Cl. 60/39.01

(57) ABSTRACT

A three or any number of sided combustion chamber with a central entrance hole through which enters air-fuel which is expoded and is exhausted through periferal exhaust ports. It causes rotation of the combustion chamber between 1,000 and 100,000 rpm. It runs a generator which can run any electrical part. The combustion chamber rotates and therefore it is the important part of the machine.

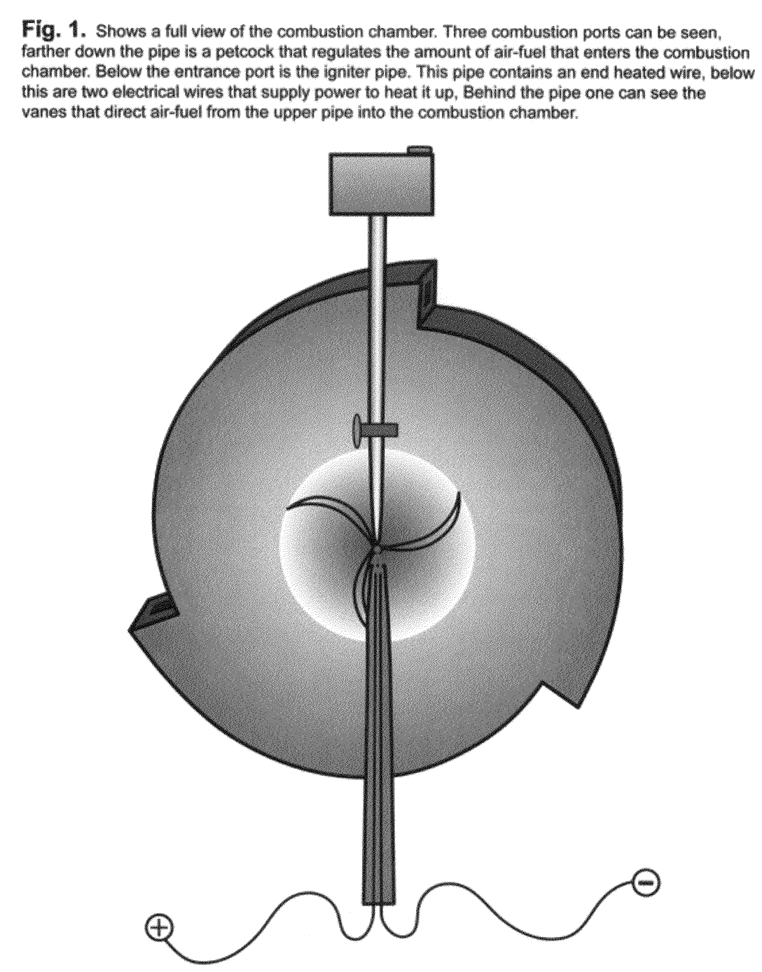

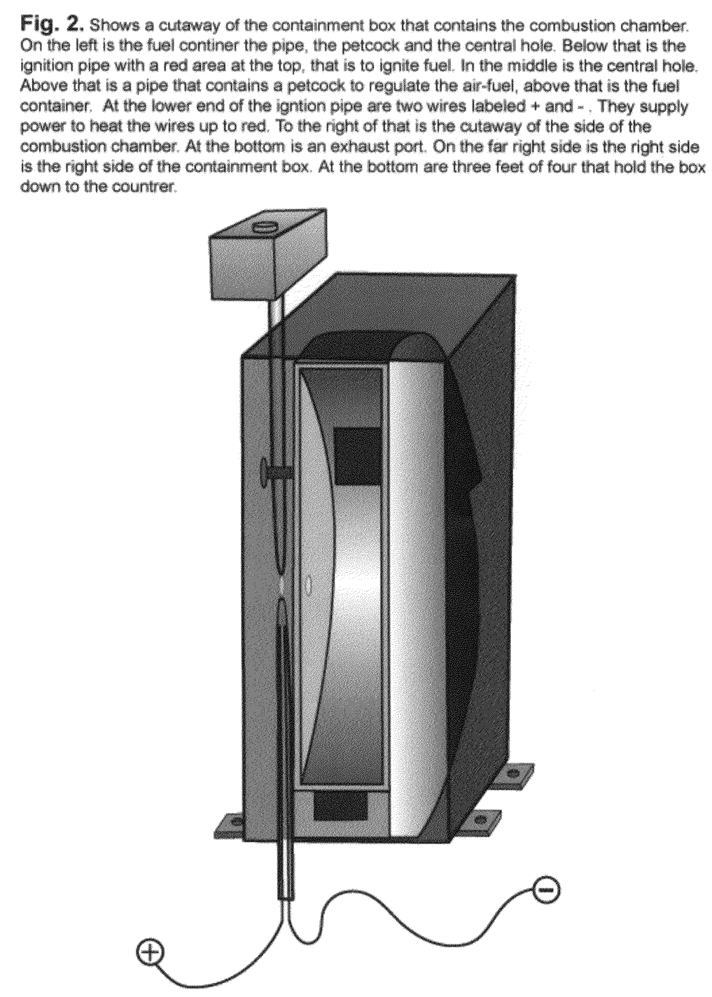

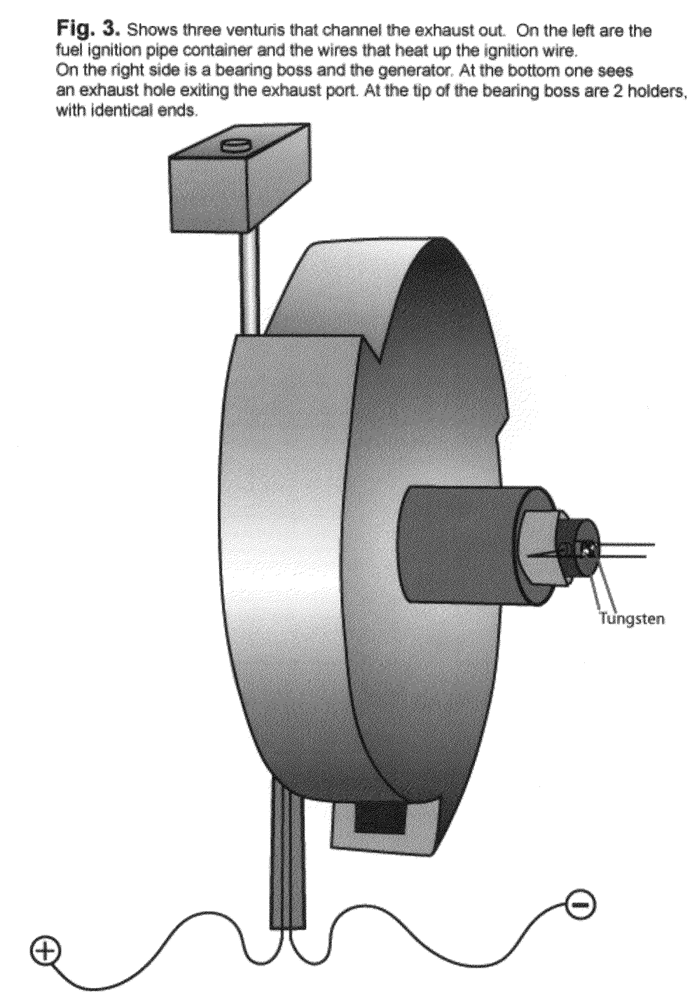

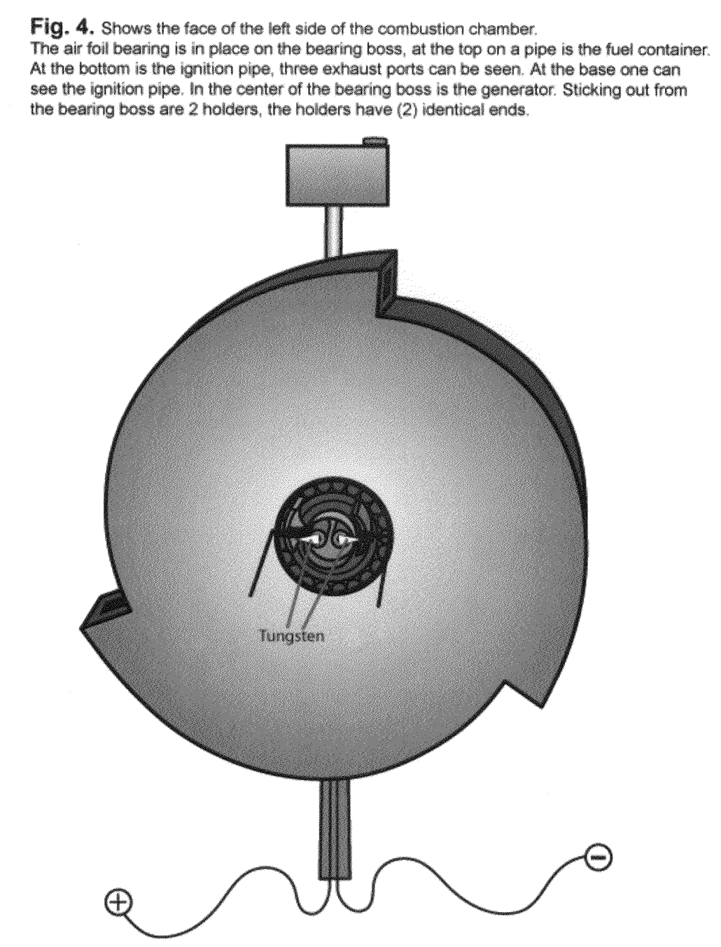

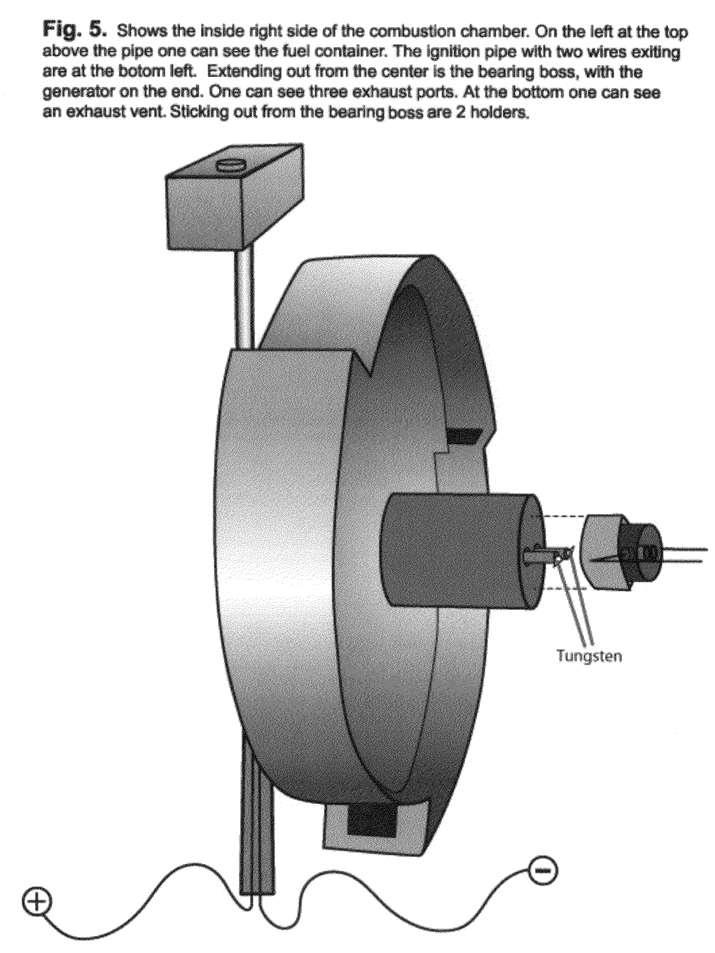

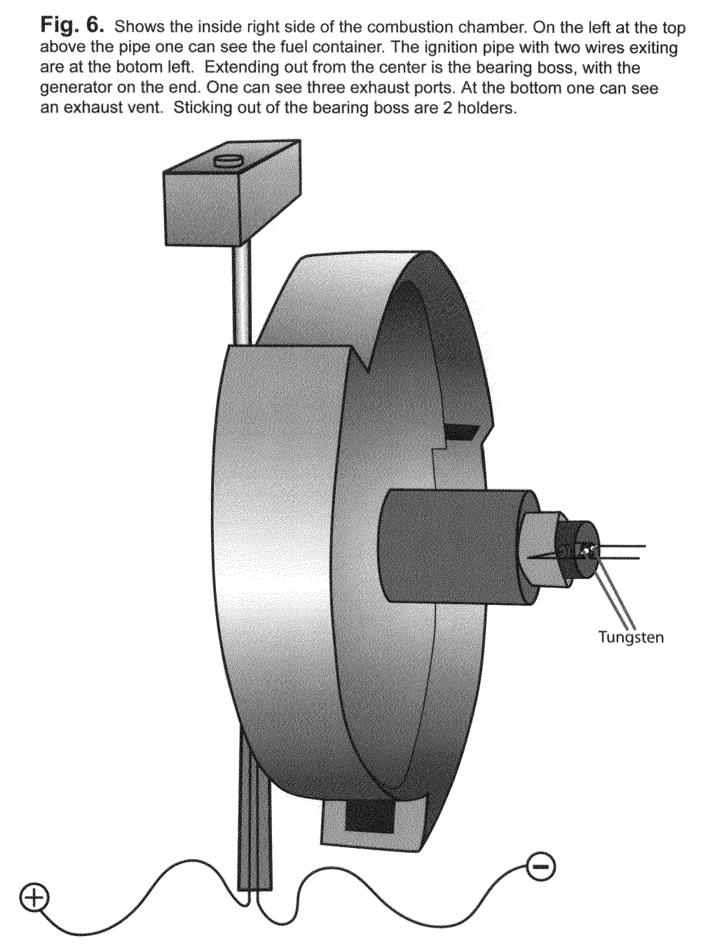

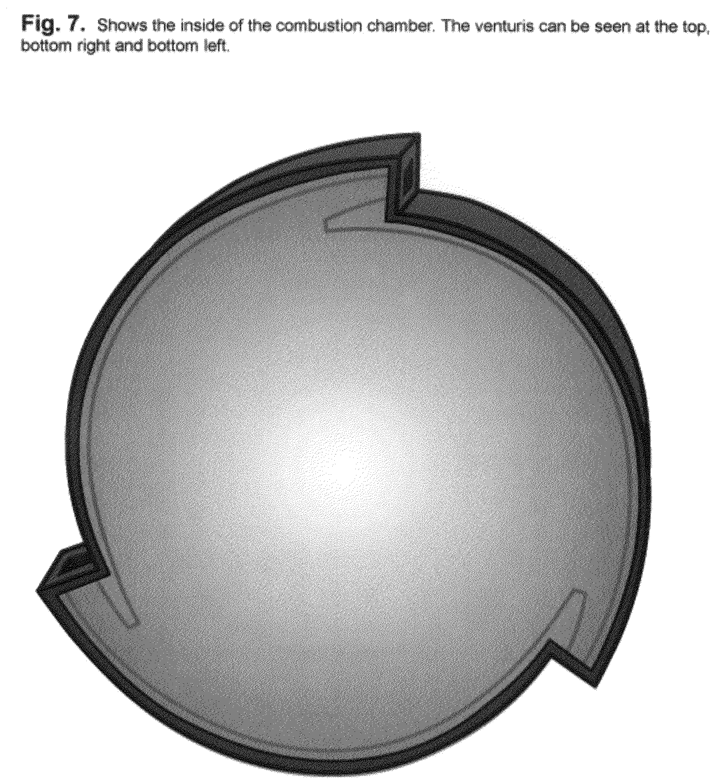

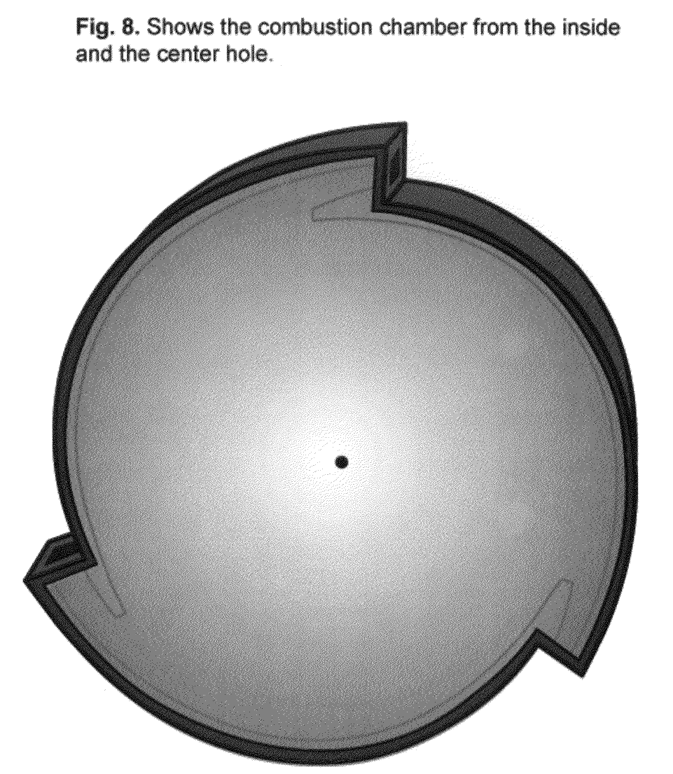

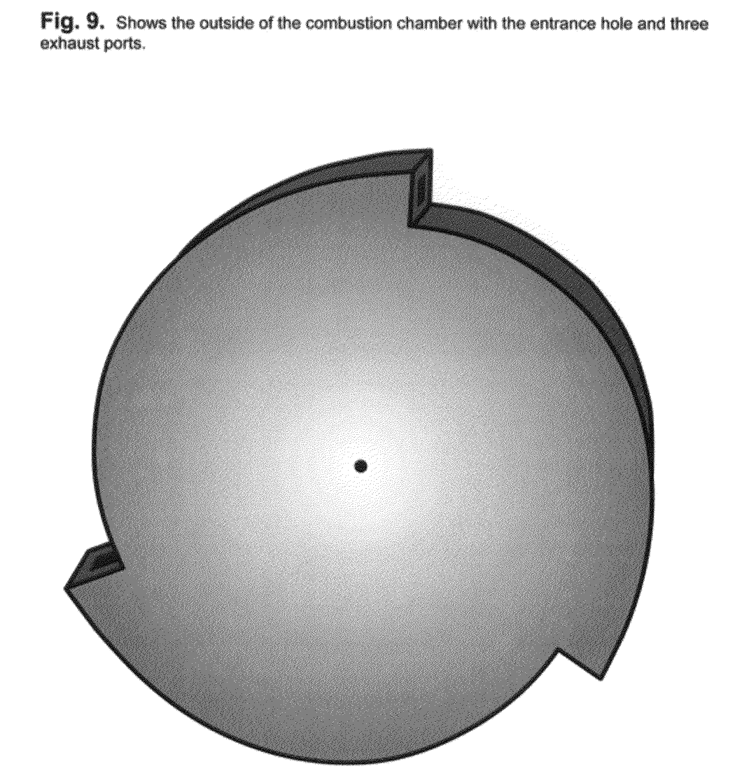

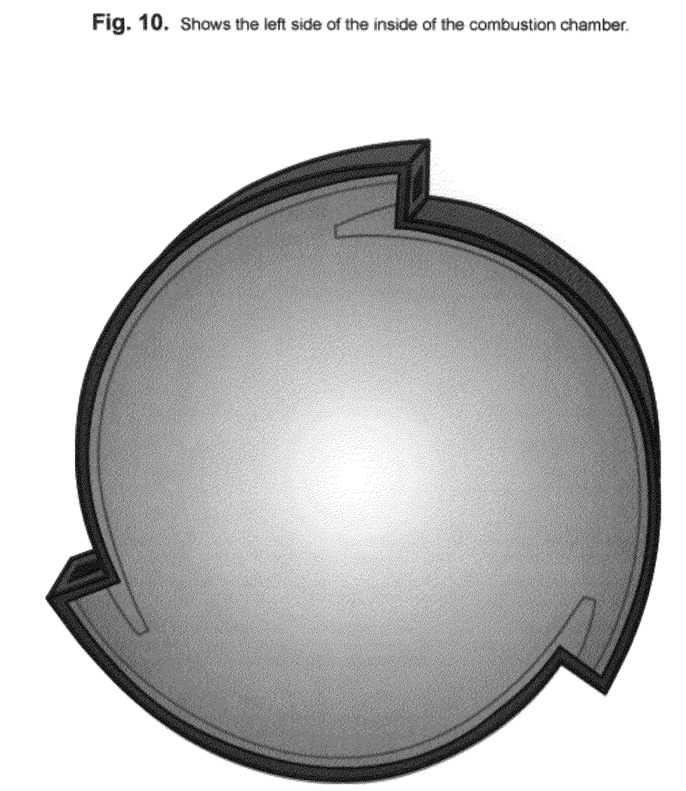

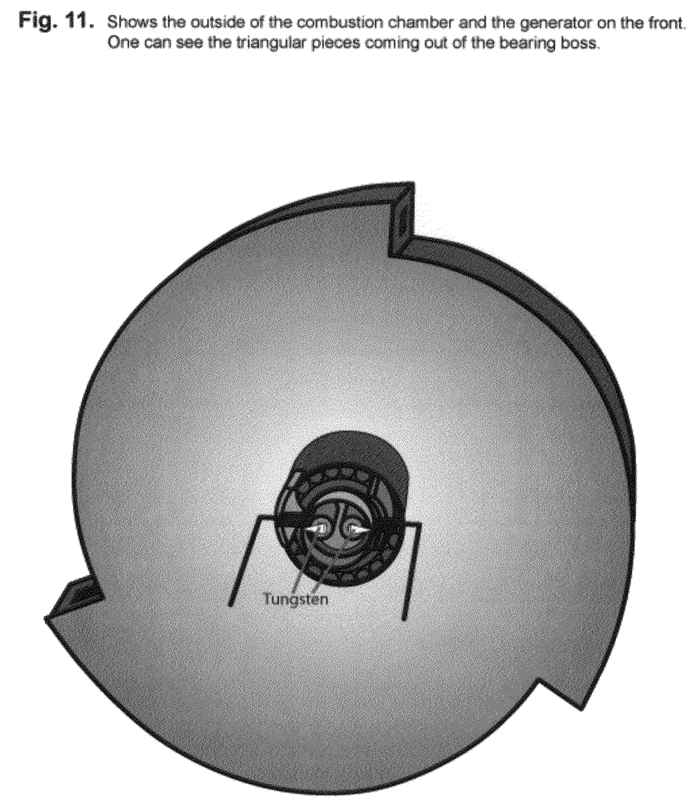

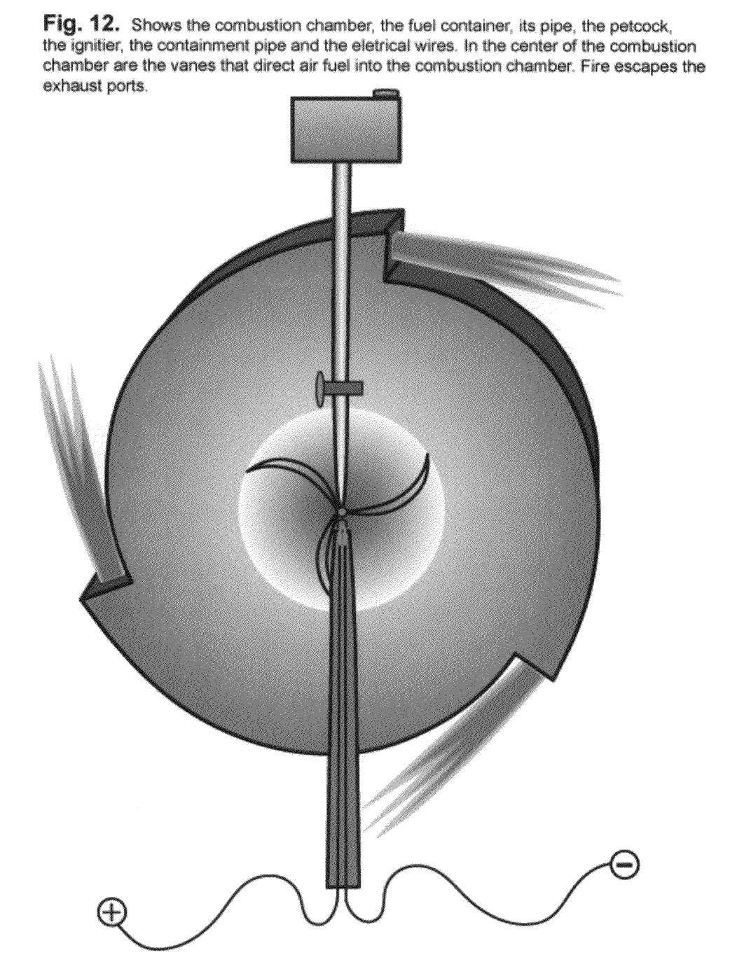

The rotary continuous internal combustion turbinel is made with moulds into which is poured silicone oxide. The silicone oxide is fired until it is hard then it is removed from the moulds.

### CROSS REFERENCE TO RELATED APPLICATIONS

None.

The air-foil bearing and generator should be excluded from this patent.

### STATEMENT REGARDING FEDERALLY SPONSORED RESERCH

None.

### BACKGROUND OF THE INVENTION

I first thought of this invention in 1965 while walking across my stepfathers, Maurice Rosenthal M.D.s barn. I saw a discarded Briggs and Stratton engine and starting ring. I wondered whether the starting ring could be used as an engine. I made some drawings. I told a friend about it and he told his father Charles Hobbs a machinist with Kitt Peak solar observatory. He had experience building things. He made drawings and suggested making the device out of aluminum. I subsequently learned from Popular Science magazine about ceramics, I imagined that they would be better suited to the device. I practiced medicine, subseqently developed multiple sclerosis and subsequently lost the drawings and therefore, I hired Hugh Armstong here in Tucson to remake the drawings.

### BRIEF SUMMARY OF THE INVENTION

A three or any number of sided combustion chamber with a central entrance hole through which enters airfuel which is expoded and is exhausted through periferal exhaust ports. It causes rotation of the combustion chamber. At hulagal.com a three sided combustion chamber is shown as an example.

### DETAILED DESCRIPTION OF THE INVENTION

A three or any number of sided combustion chamber with a central entrance hole through which enters air-fuel which is expoded and is exhausted through periferal exhaust ports. It causes rotation of the combustion chamber between 1,000 and 100,000 rpm. The combustion chamber rotates and therefore it is the important part of the machine.

1. I claim that the rotary, continuous, internal, combustion turbine will operate with one moving part.
